(19) United States
(12) Patent Application Publication
(10) Pub. No.: US 2022/0325579 A1
(43) Pub. Date: Oct. 13, 2022

(54) ROLLER BLIND DEVICE WITH STEPLESS ADJUSTMENT

(71) Applicant: Yung-Cheng WU, KAOHSIUNG (TW)

(72) Inventor: Yung-Cheng WU, KAOHSIUNG (TW)

(21) Appl. No.: 17/229,464

(22) Filed: Apr. 13, 2021

(51) Int. Cl. E06B 9/74; E06B 9/44; E06B 9/58; E06B 9/62

(52) U.S. Cl. CPC E06B 9/74; E06B 9/44; E06B 9/58; E06B 9/62; E06B 2009/402

(57) ABSTRACT

The invention provides a roller blind device with stepless adjustment comprising a roller blind base, a reel unit pivotally disposed on the roller blind base, and a blind fabric assembled on the reel unit, the reel unit comprises a first positioning unit, a second positioning unit, an outer tube accommodates the first positioning unit and the second positioning unit, a rotating shaft is assembled with the first positioning unit, and a first elastic member is disposed on the rotating shaft. Thereby, after a user combines the reel unit assembled with the blind fabric and the roller blind base, the user can drive the connected first elastic member to contract or loosen by adjusting the first positioning unit, so that a counterweight relationship between the reel unit and the blind fabric can be adjusted to achieve the roller blind device with stepless adjustment capable of adjusting a counterweight relationship.

### FIELD OF THE INVENTION

The invention relates to a blind structure, and more particularly to a roller blind device with stepless adjustment capable of adjusting a counterweight relationship between a retracting device and a roller blind.

### BACKGROUND OF THE INVENTION

Blinds or shades on the market generally have many different forms, such as roller blind, Roman blind, cellular blind and folded blind. Among them, the roller blind is a flat blind fabric that is rolled on a reel or roller, and then used with a cord or a bead string to drive the reel to achieve an effect of retracting and hanging down the roller blind.

Furthermore, because these roller blinds are driven by a cord or a bead string, and if the cord or the bead string is not handled safely when it is not being used, children will often play with the cord or the bead string because of their curiosity, which can easily cause unnecessary accidents.

Therefore, it is necessary to improve the prior art by providing a roller blind device with stepless adjustment that does not require a cord or a bead string.

### SUMMARY OF THE INVENTION

An object of the invention is to provide a roller blind device with stepless adjustment without a cord and capable of adjusting a counterweight.

In order to achieve the above object, the invention provides a roller blind device with stepless adjustment including a roller blind base, a reel unit pivotally disposed on the roller blind base, and a blind fabric assembled on the reel unit. The reel unit includes an outer tube, two through holes respectively provided at two ends of the outer tube, an accommodating space communicating with the two through holes, a first positioning unit assembled with one of the two through holes, a second positioning unit assembled with the other one of the two through holes, a rotating shaft accommodated in the accommodating space, and a first elastic member assembled on an outer peripheral of the rotating shaft, wherein a plurality of limiting ribs are protrudingly provided in the outer tube toward the accommodating space along an axial direction of the outer tube, and one end of the rotating shaft is assembled with the first positioning unit, the first positioning unit includes a first adjusting rod, and the second positioning unit includes a second adjusting rod; the blind fabric is assembled on an outer peripheral wall of the outer tube of the reel unit, one end of the first elastic member is fixed at one end of the first positioning unit, the first adjusting rod rotates the first positioning unit to drive the rotating shaft and the first elastic member, and the other end of the first elastic member is displaced in the accommodating space along the axial direction of the rotating shaft.

Further, the first positioning unit further comprises a first connecting member, a second connecting member and a third connecting member, the first adjusting rod is pivotally connected with and sleeved by the first connecting member, the second connecting member and the third connecting members, the second connecting member is positioned between the first connecting member and the third connecting member, and one end of the first connecting member is fixed with the first elastic member.

Further, the second connecting member is recessed to provide with a first accommodating chamber for assembling with the first connecting member, a limiting block is protrudingly formed on an outer peripheral of the first adjusting rod in a radial direction thereof and located in the first accommodating chamber, and a second elastic member is accommodated in the first accommodating chamber.

Further, the first connecting member is protrudingly provided with a guide block and a guide opening adjacent to the guide block along a radial direction of the first connecting member, the guide block is accommodated in the first accommodating chamber to make the limiting block moving in the guide opening, and the second elastic member is disposed on an outer peripheral of the guide block.

Further, the second positioning unit includes a plurality of positioning members protrudingly provided on an outer peripheral thereof a second accommodating chamber provided with the second adjusting rod for passing through, and a third elastic member sleeved on an outer peripheral of the second adjusting rod, wherein diameter widths of openings at two ends of the second accommodating chamber are different.

Further, the second adjusting rod is provided with a stop portion to abut against one end of the third elastic member, and a snap portion is provided at the other end of the second adjusting rod 232 opposite to the stop portion, the snap portion is snapped and limited in an opening at one end of the second accommodating chamber, and the third elastic member is limited between the stop portion and the snap portion.

Further, the first adjusting rod is recessed to form an adjusting groove at one end opposite to the rotating shaft.

Further, the outer tube of the reel unit is provided with two retractors.

Further, one end of the blind fabric is assembled with the outer tube, and the other end of the blind fabric is assembled with a counterweight rod which is recessed to provide with an accommodating slot and a pull rod accommodated in the accommodating slot.

Therefore, the invention includes the following beneficial efficacies compared with the prior art:

the roller blind device with stepless adjustment of the invention drives the first elastic member accommodated in the outer tube through the first adjusting rod, thereby a user is capable of quickly adjusting a counterweight relationship between the reel unit and the blind fabric assembled on the reel unit, and controlling retracting the roller blind or hanging the roller blind down to any desired height position.

### BRIEF DESCRIPTION OF THE DRAWINGS

FIG. 1 is a perspective exploded view of an adjustable stepless roller blind device of the invention;

FIG. 2 is a perspective assembled view of the adjustable stepless roller blind device of the invention;

FIG. 3A is a side view of a reel unit of the adjustable stepless roller blind device of the invention;

FIG. 3B is a cross-sectional view of FIG. 3A along section line 3B-3B;

FIG. 3C is a cross-sectional view of FIG. 3A along section line 3C-3C;

FIG. 3D is a partial enlarged schematic diagram of circled 3D of FIG. 3B;

FIG. 3E is a partial enlarged schematic diagram of circled 3E of FIG. 3B;

FIG. 4 is a perspective assembled view of the adjustable stepless roller blind device of the invention with a cellular blind fabric; and

FIG. 5 is a perspective assembled view of the adjustable stepless roller blind device of the invention provided with a counterweight rod.

### DETAILED DESCRIPTION OF THE PREFERRED EMBODIMENTS

The technical features and operation modes of the present application described in the following preferred embodiments in conjunction with the accompanying figures are provided as reference for examining. In addition, the figures in the invention are not drawn according to actual scales in order to facilitate illustrating the proportions. The proportions in the figures are not intended to limit the scope of the requested claims.

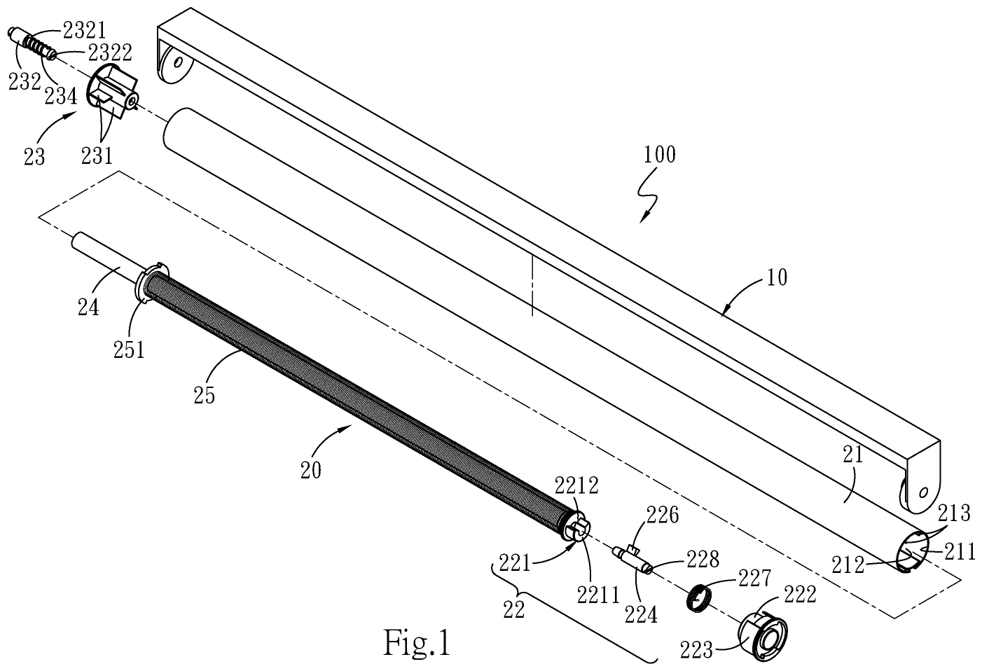

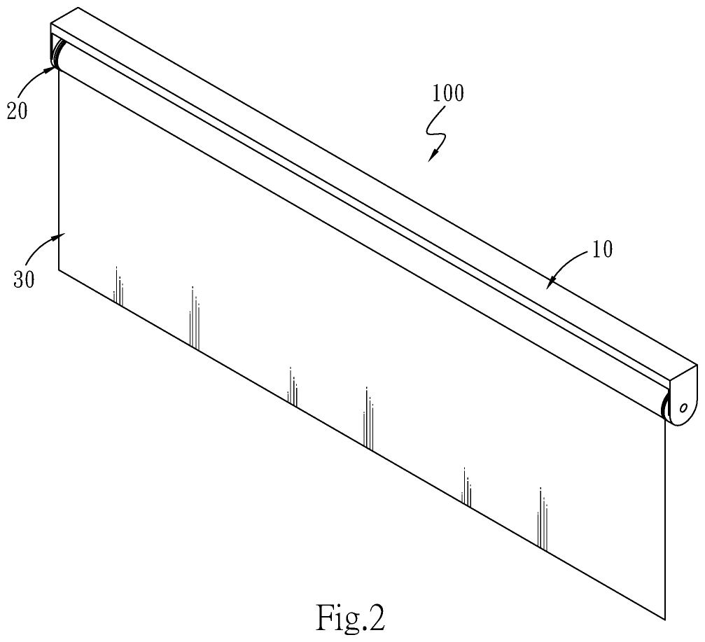

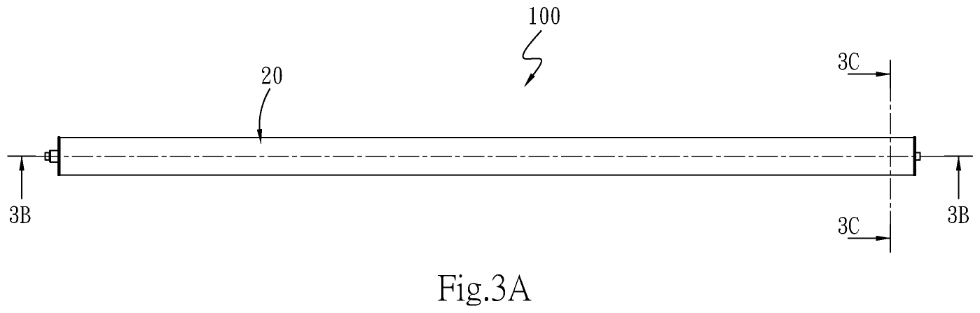

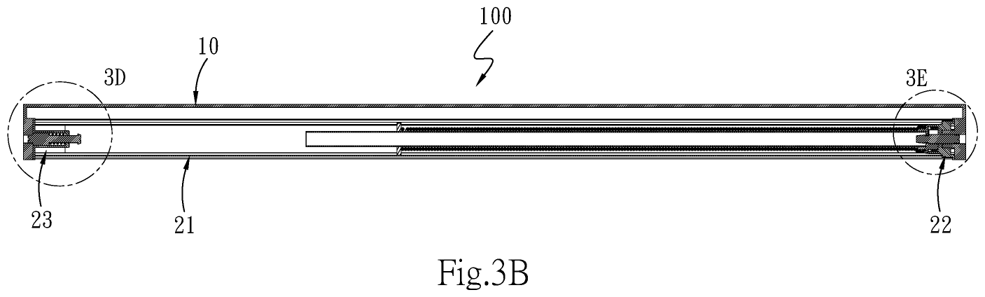

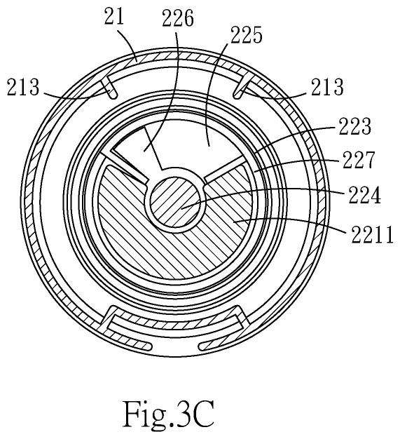

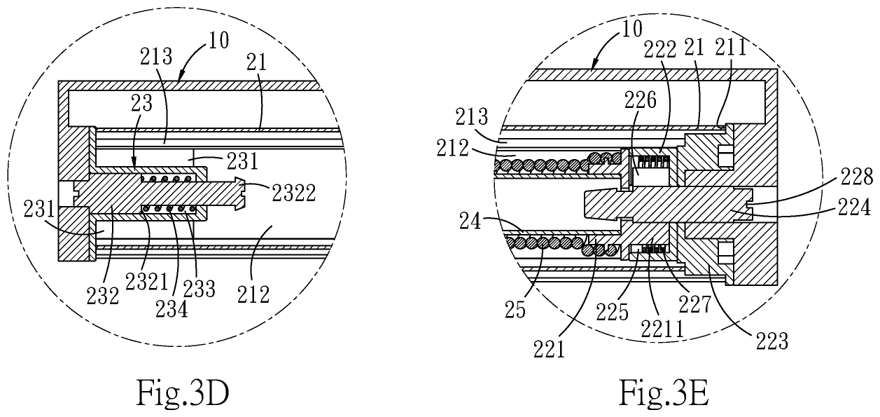

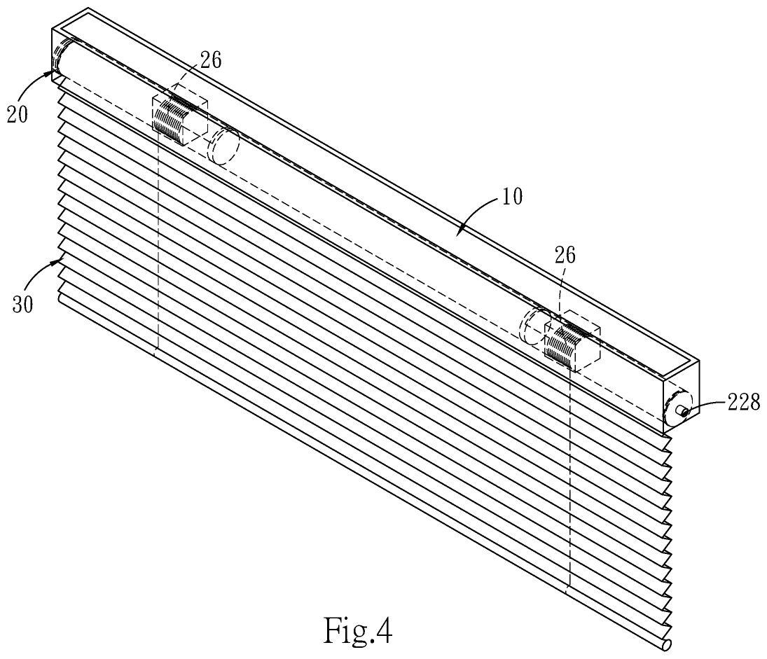

For the techniques of the invention, please refer to FIG. 1, FIG. 2, FIG. 3A, FIG. 3B, FIG. 3C, FIG. 3D and FIG. 3E. The invention provides a roller blind device 100 with stepless adjustment mainly including a roller blind base 10, a reel unit 20 pivotally disposed on the roller blind base 10, and a blind fabric 30 assembled on the reel unit 20.

The roller blind base 10 is disposed on a wall which the roller blind base 10 is to be fixed thereon.

The reel unit 20 is pivotally disposed on the roller blind base 10. The reel unit 20 includes an outer tube 21, two through holes 211 respectively provided at two ends of the outer tube 21, an accommodating space 212 communicating with the two through holes 211, a first positioning unit 22 assembled with one of the two through holes 211, a second positioning unit 23 assembled with the other one of the two through holes 211, a rotating shaft 24 accommodated in the accommodating space 212, and a first elastic member 25 assembled on an outer peripheral of the rotating shaft 24, wherein a plurality of limiting ribs 213 are protrudingly provided in the outer tube 21 toward the accommodating space 212 along an axial direction of the outer tube 21, and one end of the rotating shaft 24 is assembled with the first positioning unit 22. Please refer to FIG. 3D and FIG. 3E, the first positioning unit 22 further includes a first connecting member 221, a second connecting member 222, a third connecting member 223, and a first adjusting rod 224. The first adjusting rod 224 is pivotally connected with and sleeved by the first connecting member 221, the second connecting member 222, and the third connecting member 223. The second connecting member 222 is recessed to provide with a first accommodating chamber 225 for assembling with the first connecting member 221. A limiting block 226 is protrudingly formed on an outer peripheral of the first adjusting rod 224 in a radial direction thereof and located in the first accommodating chamber 225. A second elastic member 227 is accommodated in the first accommodating chamber 225. One end of the first elastic member 25 is fixed with the first connecting member 221, and the other end of the first elastic member 25 is provided with a positioning block 251 which is disposed around the outer peripheral of the rotating shaft 24 and located inside the outer tube 21. The positioning block 251 is provided for enabling the first elastic member 25 to displace along an axial direction of the rotating shaft 24. One end of the first adjusting rod 224 opposite to the rotating shaft 24 is recessed to form an adjusting groove 228. Please refer to FIG. 1 and FIG. 3C, the first connecting member 221 is protrudingly provided with a guide block 2211 and a guide opening 2212 adjacent to the guide block 2211 along a radial direction of the first connecting member 221, the guide block 2211 is accommodated in the first accommodating chamber 225 to make the limiting block 226 moving in the guide opening 2212, and the second elastic member 227 is disposed on an outer peripheral of the guide block 2211, and two fixing members (not numbered) are protrudingly provided to limit the second elastic member 227 in the first accommodating chamber 225. Furthermore, the second positioning unit 23 includes a plurality of positioning members 231 which are protrudingly provided on an outer peripheral thereof, a second adjusting rod 232, a second accommodating chamber 233 provided with the second adjusting rod 232 for passing through, and a third elastic member 234 sleeved on an outer peripheral of the second adjusting rod 232, wherein diameter widths of openings at two ends of the second accommodating chamber 233 are different. The second adjusting rod 232 is provided with a stop portion 2321 to abut against one end of the third elastic member 234, and a snap portion 2322 is provided at the other end of the second adjusting rod 232 opposite to the stop portion 2321, the snap portion 2322 is snapped and limited in an opening at one end of the second accommodating chamber 233, and the third elastic member 234 is limited between the stop portion 2321 and the snap portion 2322.

The blind fabric 30 is assembled on an outer peripheral wall of the outer tube 21 of the reel unit 20.

One end of the first elastic member 25 is fixed at one end of the first positioning unit 22, the first adjusting rod 224 rotates the first positioning unit 22 to drive the rotating shaft 24 and the first elastic member 25, and the other end of the first elastic member 25 is displaced in the accommodating space 212 along the axial direction of the rotating shaft 24, so that the first elastic member 25 generates different elastic restoring forces, allowing a user to conveniently adjust a counterweight relationship between the blind fabric 30 and the reel unit 20, thereby facilitating stepless adjustment of a height of the blind fabric 30.

Please refer to FIG. 4, the user can change the blind fabric 30 to have a cellular shape according to requirements, one end of the blind fabric 30 in cellular shape is assembled with the reel unit 20, the outer tube 21 is additionally provided with two retractors 26, each of the two retractors 26 includes a retracting cord, one end of each of the two retracting cords is fixed to the corresponding retractor 26, and the other end of each of the two retracting cords passes through the blind fabric 30 to be fixedly assembled at the one end of the blind fabric 30 in cellular shape, so that the roller blind device 100 with stepless adjustment is capable of conveniently rolling up and unfolding the blind fabric 30 by using the two retractors 26, and adjusting a counterweight between the blind fabric 30 and the reel unit 20 through the adjusting groove 228.

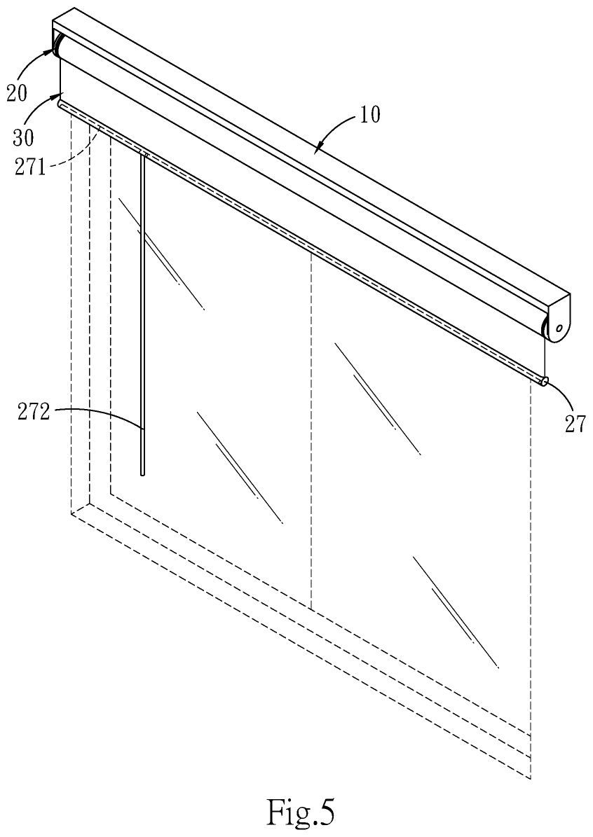

Please refer to FIG. 5, since each user has a different height, the other end of the blind fabric 30 of the roller blind device 100 with stepless adjustment is assembled with a counterweight rod 27 which is recessed to provide with an accommodating slot 271 and a pull rod 272 accommodated in the accommodating slot 271, wherein one end of the pull rod 272 is pivotally connected to the counterweight rod 27. The user is able to move out one end of the pull rod 272 where is not pivotally disposed in the accommodating slot 271 from the accommodating slot 271, and adjust the blind fabric 30 through the pull rod 272 to a required position, and then push the pull rod 272 back into the accommodating slot 271. Therefore, the use is convenient to use the roller blind device 100 with stepless adjustment and store the pull rod 272 in the accommodating slot 271.

Thereby, after the roller blind base 10 is fixed on a wall surface, the reel unit 20 can be pivotally disposed on the roller blind base 10, and the blind fabric 30 is first rolled up and folded on the outer tube 21. At this time, the user can abut a flathead screwdriver in the adjusting groove 228 of the first adjusting rod 224, and rotate the first adjusting rod 224 in a clockwise or counterclockwise direction, and the first adjusting rod 224 will drive the rotating shaft 24 fixed with the first connecting member 221 to rotate, thereby causing the first elastic member 25 to compress or decompress, in this way, the user is capable of using this function to adjust the counterweight.

In summary, the roller blind device 100 with stepless adjustment of the invention drives the first elastic member 25 accommodated in the outer tube 21 through the first adjusting rod 224, thereby the user is capable of quickly adjusting a counterweight relationship between the reel unit 20 and the blind fabric 30 assembled on the reel unit 20, and controlling retracting the blind fabric 30 or hanging the blind fabric 30 down to any desired height position.

What is claimed is:

1. A roller blind device with stepless adjustment comprising:
a roller blind base;
a reel unit pivotally disposed on the roller blind base, the reel unit comprising an outer tube, two through holes respectively provided at two ends of the outer tube, an accommodating space communicating with the two through holes, a first positioning unit assembled with one of the two through holes, a second positioning unit assembled with the other one of the two through holes, a rotating shaft accommodated in the accommodating space, and a first elastic member assembled on an outer peripheral of the rotating shaft, wherein a plurality of limiting ribs are protrudingly provided in the outer tube toward the accommodating space along an axial direction of the outer tube, and one end of the rotating shaft is assembled with the first positioning unit, the first positioning unit comprises a first adjusting rod, and the second positioning unit comprises a second adjusting rod; and
a blind fabric assembled on an outer peripheral wall of the outer tube of the reel unit;
wherein one end of the first elastic member is fixed at one end of the first positioning unit;
wherein the first adjusting rod rotates the first positioning unit to drive the rotating shaft and the first elastic member, and the other end of the first elastic member is displaced in the accommodating space along the axial direction of the rotating shaft.

2. The roller blind device with stepless adjustment as claimed in claim 1, the first positioning unit further comprising a first connecting member, a second connecting member and a third connecting member, the first adjusting rod is pivotally connected with and sleeved by the first connecting member, the second connecting member and the third connecting member, the second connecting member being positioned between the first connecting member and the third connecting member, and one end of the first connecting member being fixed with the first elastic member.

3. The roller blind device with stepless adjustment as claimed in claim 2, the second connecting member being recessed to provide with a first accommodating chamber for assembling with the first connecting member, a limiting block being protrudingly formed on an outer peripheral of the first adjusting rod in a radial direction thereof and located in the first accommodating chamber, and a second elastic member being accommodated in the first accommodating chamber.

4. The roller blind device with stepless adjustment as claimed in claim 3, the first connecting member being protrudingly provided with a guide block and a guide opening adjacent to the guide block along a radial direction of the first connecting member, the guide block being accommodated in the first accommodating chamber to make the limiting block moving in the guide opening, and the second elastic member being disposed on an outer peripheral of the guide block.

5. The roller blind device with stepless adjustment as claimed in claim 1, the second positioning unit comprising a plurality of positioning members protrudingly provided on an outer peripheral thereof, a second accommodating chamber provided with the second adjusting rod for passing through, and a third elastic member sleeved on an outer peripheral of the second adjusting rod, wherein diameter widths of openings at two ends of the second accommodating chamber are different.

6. The roller blind device with stepless adjustment as claimed in claim 5, the second adjusting rod being provided with a stop portion to abut against one end of the third elastic member, and a snap portion being provided at the other end of the second adjusting rod opposite to the stop portion, the snap portion being snapped and limited in an opening at one end of the second accommodating chamber, and the third elastic member being limited between the stop portion and the snap portion.

7. The roller blind device with stepless adjustment as claimed in claim 1, wherein the first adjusting rod is recessed to form an adjusting groove at one end opposite to the rotating shaft.

8. The roller blind device with stepless adjustment as claimed in claim 1, the outer tube of the reel unit being further provided with two retractors.

9. The roller blind device with stepless adjustment as claimed in claim 1, further, one end of the blind fabric being assembled with the outer tube, and the other end of the blind fabric being assembled with a counterweight rod which is recessed to provide with an accommodating slot and a pull rod accommodated in the accommodating slot.
